(19) United States
(12) Patent Application Publication
(10) Pub. No.: US 2026/0282004 A1
(43) Pub. Date: Sep. 17, 2026

(54) HANDLING OF MULTIPLE FREQUENCY GRANULARITIES FOR IDC

(71) Applicant: Telefonaktiebolaget LM Ericsson (publ), Stockholm (SE)

(72) Inventor: Mattias Bergström, Stockholm (SE)

(21) Appl. No.: 19/106,399

(22) PCT Filed: Sep. 7, 2023
(86) PCT No.: PCT/IB2023/058863

§ 371 Date: Feb. 25, 2025

Related U.S. Application Data
(60) Provisional application No. 63/404,666, filed on Sep. 8, 2022.

(51) Int. Cl. H04W 72/12; H04W 72/0453

(52) U.S. Cl. CPC H04W 72/1215; H04W 72/0453

(57) ABSTRACT

Systems and methods are disclosed that relate to handling multiple frequency granularities for In-Device Co-existence (IDC). In one embodiment, a method performed by a User Equipment (UE) comprises receiving, from a network node, information that explicitly or implicitly indicates one or more granularities to be used by the UE for IDC Frequency Domain Multiplexing (FDM) indications, the one or more granularities being one or more of a predefined or configured set of two or more granularities that can be used for IDC FDM indications. The method further comprises providing, to the network node, one or more IDC FDM indications in accordance with the information. In this manner, operation of a UE that is capable of sending IDC FDM indications using different granularities is defined.

### RELATED APPLICATIONS

This application claims the benefit of provisional patent application Ser. No. 63/404,666, filed Sep. 8, 2022, the disclosure of which is hereby incorporated herein by reference in its entirety.

### TECHNICAL FIELD

The present disclosure relates to a cellular communications system and, more specifically, to an In-Device Coexistence (IDC) feature in a cellular communication system.

### BACKGROUND

The In-Device Coexistence (IDC) feature was introduced in 3^{rd} Generation Partnership Project (3GPP) Long Term Evolution (LTE) and New Radio (NR). This feature was introduced to tackle situations when a User Equipment (UE) is operating multiple radio technologies and the radios used for these different technologies cause interference to each other. An example is shown in FIG. 1 where transmissions by an LTE transmitter are causing interference to a Global Positioning System (GPS) receiver and a Bluetooth/Wireless Local Area Network (WLAN) receiver, as well as the Bluetooth/WLAN receiver is causing interference to the LTE receiver. Note, the IDC feature is here described using LTE as an example 3GPP Radio Access Technology (RAT), but on a high level, the IDC feature is similar for NR.

When the UE identifies that there is IDC type of interference, the UE first tries to solve the problem internally. If this fails, the UE can indicate to the evolved NodeB (eNB) that the UE is experiencing IDC problems which it cannot solve by itself. Note that how the UE detects IDC problems is left to implementation.

First, the UE indicates the frequencies that are suffering from IDC interference and optionally signals the technology that causes the interference, for instance that the interference comes from WLAN. In addition, if the UE determines that the IDC problems can be solved in a Time Domain Multiplexing (TDM)-manner (i.e., by multiplexing the use of the interfering transceivers in time), the UE can indicate a bit-map or Discontinuous Reception (DRX) cycles to the eNB which indicates which Transmit Time Intervals (TTIs) are affected by IDC interference.

When the eNB gets the indication, it can take action to solve the problem. For example, the eNB may handover the UE to another frequency, remove (in case of Carrier Aggregation (CA)) the problematic cells, or configure the UE with a DRX-configuration which would solve the problem. Note, at least up to Rel-17, the NR specification does not support the TMD-indications for IDC.

An example scenario where the IDC feature is useful is when the UE is using an LTE carrier in band 40 at the same time as it is using WLAN in the 2.4 Gigahertz (GHz) band. There may be IDC problems in this scenario since these frequency bands are next to each other as shown in FIG. 2. The UE would then try to solve the problems internally. However, if it cannot do so, the UE will indicate to the eNB that the serving cell on band 40 is having an IDC problem, and the eNB can then handover the UE to another frequency or reconfigure the cell.

In 3GPP Technical Specification (TS) 36.331 (see, e.g., v17.1.0), IDC is described as follows:

### Start Excerpt from 3GPP TS 36.331

### 5.6.9.3 Actions Related to Transmission of InDeviceCoexIndication Message

The UE shall set the contents of the InDeviceCoexIndication message as follows:
1> if there is at least one E-UTRA carrier frequency, for which a measurement object is configured, that is affected by IDC problems:
   2> include the field affectedCarrierFreqList with an entry for each affected E-UTRA carrier frequency for which a measurement object is configured;
   2> for each E-UTRA carrier frequency included in the field affectedCarrierFreqList, include interferenceDirection and set it accordingly;
   2> include Time Domain Multiplexing (TDM) based assistance information, unless idc-HardwareSharingIndication is configured and the UE has no Time Doman Multiplexing based assistance information that could be used to resolve the IDC problems:
      3> if the UE has DRX related assistance information that could be used to resolve the IDC problems:
         4> include drx-CycleLength, drx-Offset and drx-ActiveTime;
      3> else (the UE has desired subframe reservation patterns related assistance information that could be used to resolve the IDC problems):
         4> include idc-SubframePatternList;
      3> use the MCG as timing reference if TDM based assistance information regarding the SCG is included;
1> if the UE is configured to provide UL CA information and there is a supported UL CA combination comprising of carrier frequencies for which a measurement object is configured, that is affected by IDC problems:
   2> include victimSystemType in ul-CA-AssistanceInfo;
   2> if the UE sets victimSystemType to wlan or Bluetooth:
      3> include affectedCarrierFreqCombList in ul-CA-AssistanceInfo with an entry for each supported UL CA combination comprising of carrier frequencies for which a measurement object is configured, that is affected by IDC problems;
   2> else:
      3> optionally include affectedCarrierFreqCombList in ul-CA-AssistanceInfo with an entry for each supported UL CA combination comprising of carrier frequencies for which a measurement object is configured, that is affected by IDC problems;
1> if idc-HardwareSharingIndication is configured, and there is at least one E-UTRA carrier frequency, for which a measurement object is configured, the UE is experiencing hardware sharing problems that it cannot solve by itself:
   2> include the hardwareSharingProblem and set it accordingly;
1> if the UE is configured to provide IDC indications for MR-DC and there is a supported MR-DC band combination comprising of at least one E-UTRA carrier frequency for which a measurement object is configured and at least one NR carrier frequency included in candidateServingFreqListNR, that is affected by IDC problems; and
1> if the IDC problem does not only concern the E-UTRA band combination as the UE already included in affectedCarrierFreqCombList:
   2> for each entry of affectedCarrierFreqCombInfoListMRDC in mrdc-AssistanceInfo;
      3> include victimSystemType;
      3> include interferenceDirectionMRDC;
      3> if the UE sets victimSystemType to wlan or Bluetooth:
         4> include a set of at least one NR carrier frequency included in candidateServingFreqListNR and optionally one or more E-UTRA carrier frequency for which a measurement object is configured, that is affected by IDC problems;
      3> else:
         4> optionally include a set of at least one NR carrier frequency included in candidateServingFreqListNR and optionally one or more E-UTRA carrier frequency for which a measurement object is configured, that is affected by IDC problems;
NOTE 1: When sending an InDeviceCoexIndication message to inform E-UTRAN the IDC problems, the UE includes all assistance information (rather than providing e.g. the changed part(s) of the assistance information).
NOTE 2: Upon not anymore experiencing a particular IDC problem that the UE previously reported, the UE provides an IDC indication with the modified contents of the InDeviceCoexIndication message (e.g. by an empty message).

The UE shall submit the InDeviceCoexIndication message to lower layers for transmission.

### End Excerpt from 3GPP TS 36.331

In regard to granularity of IDC Frequency Domain Multiplexing (FDM) indications, in NR Rel-16, the granularity of the IDC FDM indications is on an Absolute Radio Frequency Channel Number (ARFCN)-level. An ARFCN is a single point in frequency. However, the purpose of the IDC solution is that the UE shall be able to indicate that it is, or expects that it will be, experiencing IDC issues on a cell with which the UE is, or may be, configured. A cell has a frequency range. If the network configures the UE to consider one or more ARFCNs in the IDC feature, the UE would consider a cell which is configured around the ARFCN, i.e. to some frequency range around that ARFCN. The UE may not know the size of a potential cell that the network may configure for the UE for an ARFCN and hence the UE may need to consider the maximum frequency range of a cell, which may be, e.g., 100 Megahertz (MHz). So, if the network configures the UE to consider an ARFCN corresponding to frequency X, the UE may consider that it should report IDC issues if the UE is experiencing, or expects to experience, IDC issues between X −50 MHz to X +50 MHz.

ARFCN is a very coarse granularity. Therefore, 3GPP will in Rel-18 of NR define FDM indications of higher granularity. What that finer granularity will be is still under discussion. One proposal is that the granularity of a bandwidth part (BWP) will be used. BWPs can be a subset of a cell, and a cell can comprise several BWPs. With the BWP granularity, the network may configure candidate BWPs, and the UE would indicate if the UE is experiencing, or expects to experience, IDC issues on those BWPs.

Alternatives to BWPs that have been discussed are frequency ranges, sets of Physical Resources Blocks (PRBs), etc.

### SUMMARY

Systems and methods are disclosed that relate to handling multiple frequency granularities for In-Device Co-existence (IDC). In one embodiment, a method performed by a UE comprises receiving, from a network node, information that explicitly or implicitly indicates one or more granularities to be used by the UE for IDC Frequency Domain Multiplexing (FDM) indications, the one or more granularities being one or more of a predefined or configured set of two or more granularities that can be used for IDC FDM indications. The method further comprises providing, to the network node, one or more IDC FDM indications in accordance with the information. In this manner, operation of a UE that is capable of sending IDC FDM indications using different granularities is defined.

In one embodiment, providing the one or more IDC FDM indications in accordance with the information comprises providing the one or more IDC FDM indications using a single granularity indicated by the received information.

In one embodiment, providing the one or more IDC FDM indications in accordance with the information comprises providing the one or more IDC FDM indications using a single granularity selected from two or more granularities indicated by the received information.

In one embodiment, the one or more granularities to be used by the UE for IDC FDM indications consist of a single granularity to be used by the UE for IDC FDM indications.

In one embodiment, the information that explicitly or implicitly indicates the one or more granularities to be used by the UE for IDC FDM indications comprises information that configures one or more candidate frequency resources and, for each candidate frequency resource of the one or more candidate frequency resources configured for the UE, a granularity used to configure the candidate frequency resource serves as an implicit indication of a granularity to be used by the UE when sending an IDC FDM indication for that candidate frequency resource.

In one embodiment, the one or more granularities to be used by the UE for IDC FDM indications consists of two or more granularities, and providing the one or more IDC FDM indications in accordance with the information comprises determining one of the two or more granularities to use when providing the one or more IDC FDM indications.

In one embodiment, the one or more granularities indicated by the received information comprise two or more granularities, and providing the one or more IDC FDM indications in accordance with the information comprises providing two or more IDC FDM indications using at least two of the two or more granularities indicated by the received information.

In one embodiment, the one or more granularities indicated by the received information comprise two or more granularities, and providing the one or more IDC FDM indications in accordance with the information comprises providing two or more IDC FDM indications in accordance with the information, wherein providing the two or more IDC FDM indications comprises determining at least two of the two or more granularities to be used when providing the two or more IDC FDM indications.

In one embodiment, the one or more granularities indicated by the received information comprise two or more granularities. Providing the one or more IDC FDM indications in accordance with the information comprises determining two or more candidate frequency resources for which the UE is experiencing or is expected to experience an IDC problem, wherein at least one of the two or more candidate frequency resources is configured using a first granularity from among the two or more granularities and at least one other of the two or more candidate frequency resources is configured using a second granularity from among the two or more granularities, determining at least one of the first and second granularities to be used when sending at least one IDC FDM indication that explicitly or implicitly indicates the two or more candidate frequency resources for which the UE is experiencing or is expected to experience an IDC problem, and sending, to the network node, the at least one IDC FDM indication that explicitly or implicitly indicates the two or more candidate frequency resources for which the UE (302) is experiencing or is expected to experience an IDC problem, the at least one IDC FDM indication sent using the determined at least one of the first and second granularities.

In one embodiment, the one or more granularities indicated by the received information comprise two or more granularities, and providing the one or more IDC FDM indications in accordance with the information comprises determining two or more candidate frequency resources for which the UE is experiencing or is expected to experience an IDC problem, wherein the two or more candidate frequency resources for which the UE is experiencing or is expected to experience an IDC problem comprises a first candidate frequency resource configured using a first granularity from among the two or more granularities and a second candidate frequency resource configured using a second granularity from among the two or more granularities, and sending, to the network node, a first IDC FDM indication for the first candidate frequency resource and a second IDC FDM indication for the second candidate frequency resource, wherein the first IDC FDM indication uses the first granularity and the second IDC FDM indication uses the second granularity.

In one embodiment, the one or more granularities indicated by the received information comprise two or more granularities, and providing the one or more IDC FDM indications in accordance with the information comprises determining two or more candidate frequency resources for which the UE is experiencing or is expected to experience an IDC problem. The two or more candidate frequency resources for which the UE is experiencing or is expected to experience an IDC problem comprises a first candidate frequency resource configured using a first granularity from among the two or more granularities and s second candidate frequency resource configured using a second granularity from among the two or more granularities, wherein the first granularity is coarser than the second granularity and the first and second candidate frequency resources overlap. Providing the one or more IDC FDM indications in accordance with the information further comprises sending, to the network node, an IDC FDM indication for the second candidate frequency resource, wherein the IDC FDM indication also implicitly indicates an IDC problem for the first candidate frequency resource that overlaps the second candidate frequency resource.

In one embodiment, the one or more granularities indicated by the received information comprise two or more granularities, and providing the one or more IDC FDM indications in accordance with the information comprises determining two or more candidate frequency resources for which the UE is experiencing or is expected to experience an IDC problem. The two or more candidate frequency resources for which the UE is experiencing or is expected to experience an IDC problem comprises a first candidate frequency resource configured using a first granularity from among the two or more granularities and a second candidate frequency resource configured using a second granularity from among the two or more granularities, wherein the first granularity is coarser than the second granularity and the first and second candidate frequency resources overlap. Providing the one or more IDC FDM indications in accordance with the information further comprises sending, to the network node, an IDC FDM indication for the first candidate frequency resource, wherein the IDC FDM indication also implicitly indicates an IDC problem for the second candidate frequency resource that overlaps the second candidate frequency resource.

In one embodiment, the one or more granularities indicated by the received information comprise two or more granularities, and providing the one or more IDC FDM indications in accordance with the information comprises determining two or more candidate frequency resources for which the UE is experiencing or is expected to experience an IDC problem. The two or more candidate frequency resources for which the UE is experiencing or is expected to experience an IDC problem comprises a first candidate frequency resource configured using a first granularity from among the two or more granularities and a second candidate frequency resource configured using the first granularity, wherein the first candidate frequency resource is entirely within the second candidate frequency resource. Providing the one or more IDC FDM indications in accordance with the information further comprises sending, to the network node, an IDC FDM indication for the first candidate frequency resource, wherein the IDC FDM indication also implicitly indicates an IDC problem for the second candidate frequency resource.

Corresponding embodiments of a UE are also disclosed. In one embodiment, a UE is adapted to receive, from a network node, information that explicitly or implicitly indicates one or more granularities to be used by the UE for IDC FDM indications, the one or more granularities being one or more of a predefined or configured set of two or more granularities that can be used for IDC FDM indications. The UE is further adapted to provide, to the network node, one or more IDC FDM indications in accordance with the information.

In one embodiment, a UE comprises a communication interface and processing circuitry associated with the communication interface. The processing circuitry is configured to cause the UE to receive, from a network node, information that explicitly or implicitly indicates one or more granularities to be used by the UE for IDC FDM indications, the one or more granularities being one or more of a predefined or configured set of two or more granularities that can be used for IDC FDM indications. The processing circuitry is further configured to cause the UE to provide, to the network node, one or more IDC FDM indications in accordance with the information.

Embodiments of a method performed by a network node are also disclosed. In one embodiment, a method performed by a network node comprises sending, to a UE, information that explicitly or implicitly indicates one or more granularities to be used by the UE for IDC FDM indications, the one or more granularities being one or more of a predefined or configured set of two or more granularities that can be used for IDC FDM indications. The method further comprises receiving, from the UE, one or more IDC FDM indications in accordance with the information.

In one embodiment, the method further comprises performing one or more actions based on the one or more IDC FDM indications received from the UE.

In one embodiment, the one or more IDC FDM indications use a single granularity indicated by the information sent to the UE.

In one embodiment, the one or more IDC FDM indications use a single granularity selected from two or more granularities indicated by the information sent to the UE.

In one embodiment, the one or more granularities to be used by the UE for IDC FDM indications consist of a single granularity to be used by the UE for IDC FDM indications.

In one embodiment, the information that explicitly or implicitly indicates the one or more granularities to be used by the UE for IDC FDM indications comprises information that configures one or more candidate frequency resources and, for each candidate frequency resource of the one or more candidate frequency resources configured for the UE, a granularity used to configure the candidate frequency resource serves as an implicit indication of a granularity to be used by the UE when sending an IDC FDM indication for that candidate frequency resource.

In one embodiment, the one or more granularities to be used by the UE for IDC FDM indications consists of two or more granularities, and the one or more IDC FDM indications use at least two of the two or more granularities.

In one embodiment, the one or more granularities indicated by the received information comprise two or more granularities, and the one or more IDC FDM indications comprises a first IDC FDM indication using a first granularity from among the two or more granularities and a second IDC FDM indication using a second granularity from among the two or more granularities.

In one embodiment, the one or more granularities indicated by the information comprise two or more granularities, and the one or more IDC FDM indications comprise at least one IDC FDM indication that explicitly or implicitly indicates two or more candidate frequency resources for which the UE is experiencing or is expected to experience an IDC problem, wherein at least one of the two or more candidate frequency resources is configured to the UE using a first granularity from among the two or more granularities and at least one other of the two or more candidate frequency resources is configured to the UE using a second granularity from among the two or more granularities and the at least one IDC FDM indication is sent using at least one of the first and second granularities.

In one embodiment, the one or more granularities indicated by the received information comprise two or more granularities, the UE is configured with a plurality of candidate frequency resources comprising a first candidate frequency resource configured using a first granularity from among the two or more granularities and a second candidate frequency resource configured using a second granularity from among the two or more granularities, and the one or more IDC FDM indications comprise a first IDC FDM indication for the first candidate frequency resource and a second IDC FDM indication for the second candidate frequency resource, wherein the first IDC FDM indication uses the first granularity and the second IDC FDM indication uses the second granularity.

In one embodiment, the one or more granularities indicated by the received information comprise two or more granularities, and the UE is configured with a plurality of candidate frequency resources comprising a first candidate frequency resource configured using a first granularity from among the two or more granularities a second candidate frequency resource configured using a second granularity from among the two or more granularities, wherein the first granularity is coarser than the second granularity and the first and second candidate frequency resources overlap. Further, the one or more IDC FDM indications comprise an IDC FDM indication for the second candidate frequency resource, wherein the IDC FDM indication also implicitly indicates an IDC problem for the first candidate frequency resource that overlaps the second candidate frequency resource.

In one embodiment, the one or more granularities indicated by the received information comprise two or more granularities, and the UE is configured with a plurality of candidate frequency resources comprising a first candidate frequency resource configured using a first granularity from among the two or more granularities and a second candidate frequency resource configured using a second granularity from among the two or more granularities, wherein the first granularity is coarser than the second granularity and the first and second candidate frequency resources overlap. Further, the one or more IDC FDM indications comprise an IDC FDM indication for the first candidate frequency resource, wherein the IDC FDM indication also implicitly indicates an IDC problem for the second candidate frequency resource that overlaps the first candidate frequency resource.

In one embodiment, the one or more granularities indicated by the received information comprise two or more granularities, and the UE is configured with a plurality of candidate frequency resources comprising a first candidate frequency resource configured using a first granularity from among the two or more granularities and a second candidate frequency resource configured using the first granularity, wherein the first candidate frequency resource overlaps (e.g., is entirely within) the second candidate frequency resource. Further, the one or more IDC FDM indications comprise an IDC FDM indication for the first candidate frequency resource, wherein the IDC FDM indication also implicitly indicates an IDC problem for the second candidate frequency resource.

Corresponding embodiments of a network node are also disclosed. In one embodiment, a network node is adapted to send, to a UE, information that explicitly or implicitly indicates one or more granularities to be used by the UE for IDC FDM indications, the one or more granularities being one or more of a predefined or configured set of two or more granularities that can be used for IDC FDM indications. The network node is further adapted to receive, from the UE, one or more IDC FDM indications in accordance with the information.

In one embodiment, a network node comprises processing circuitry configured to cause the network node to send, to a UE, information that explicitly or implicitly indicates one or more granularities to be used by the UE for IDC FDM indications, the one or more granularities being one or more of a predefined or configured set of two or more granularities that can be used for IDC FDM indications. The processing circuitry is further configured to cause the network node to receive, from the UE, one or more IDC FDM indications in accordance with the information.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of the In-Device Coexistence (IDC) feature introduced in 3^{rd} Generation Partnership Project (3GPP) Long Term Evolution (LTE) and New Radio (NR);

FIG. 2 illustrates an example scenario in which IDC problems may arise because frequency bands are next to each other;

FIG. 3 illustrates the operation of a network node and a User Equipment (UE), in accordance with at least some of the embodiments described herein;

FIG. 4 shows a scenario where the UE is configured with candidate frequency resources with two different granularities: Absolute Radio Frequency Channel Numbers (ARFCNs) and Bandwidth Parts (BWPs);

FIG. 5 illustrates an example related to the scenario of FIG. 4 in which the UE would indicate ARFCN 2 and BWP C as problematic resources, i.e. the UE would include frequency resources of different granularities in the report, in accordance with one example embodiment of the present disclosure;

FIG. 6 illustrates an example related to the scenario of FIG. 4 in which the UE would only indicate ARFCN 2 as problematic since no other frequency resource is affected, in accordance with one example embodiment of the present disclosure;

FIG. 7 illustrates an example scenario where all BWPs (i.e., both BWP A and BWP B in the figure) are affected by IDC problems, and the UE would, if it is applying an example signaling optimization, only indicate ARFCN 1 which would then mean that all BWPs (A and B) associated with this ARFCN are affected by IDC problems, in accordance with one example embodiment of the present disclosure;

FIG. 8 illustrates an example embodiment in which the UE is configured with candidate frequency resources of the same granularity which are overlapping;

FIG. 9 illustrates an example related to the embodiment of FIG. 8 in which the UE may experience IDC problems which affect only one of the frequency resources;

FIG. 10 illustrates an example scenario in which the UE may experience IDC problems which affects two overlapping candidate frequencies resources;

FIG. 11 shows an example of a communication system, in accordance with some embodiments;

FIG. 12 shows a UE in accordance with some embodiments;

FIG. 13 shows a network node in accordance with some embodiments;

FIG. 14 is a block diagram of a host, which may be an embodiment of the host of FIG. 11, in accordance with various aspects described herein;

FIG. 15 is a block diagram illustrating a virtualization environment in which functions implemented by some embodiments may be virtualized; and

FIG. 16 shows a communication diagram of a host communicating via a network node with a UE over a partially wireless connection in accordance with some embodiments.

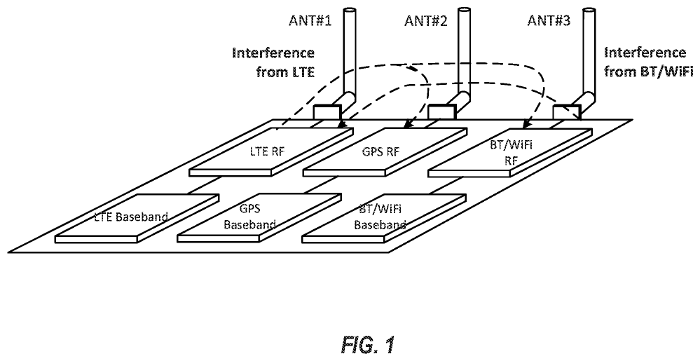

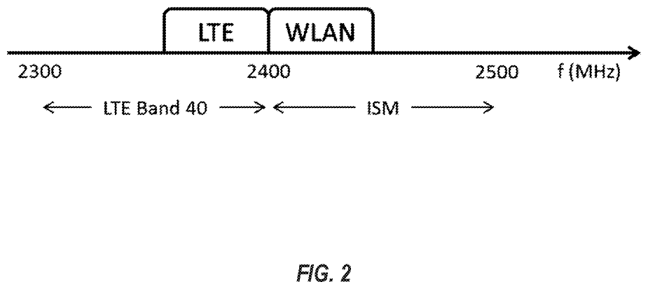

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). In Rel-18, there will be multiple sets of granularity for In-Device Coexistence (IDC) Frequency Division Multiplexing (FDM) indications including Absolute Radio Frequency Channel Numbers (ARFCNs) (as defined in New Radio (NR) Rel-16), bandwidth parts (BWPs) or frequency ranges, etc. (as defined in Rel-18 of NR). It is unclear how these multiple granularities for the IDC FDM indications could co-exist in the specification.

Certain aspects of the disclosure and their embodiments may provide solutions to these or other challenges. Embodiments of systems and methods for handling cases when a User Equipment (UE) is capable of a plurality of granularities for IDC FDM-indications are disclosed herein.

In some embodiments, the UE is capable of sending IDC indications of multiple granularities, but the UE determines one of these granularities to apply. This may be based on a network indication to the UE. The network may then choose one of the granularities that the UE supports and indicate (implicitly or explicitly) which granularity the UE shall apply.

Some embodiments describe the scenario where the UE applies IDC indications of multiple granularities and embodiments describe what the UE signals to the network depending on which frequency resources are affected.

Certain embodiments may provide one or more of the following technical advantage(s). Embodiments of systems and methods are provided that relate to how a UE that is capable of sending IDC FDM indications using different granularities can operate. IDC indications can be provided using an appropriate granularity (e.g., based on what the network considers appropriate). Also, in cases where different granularities are configured simultaneously for a UE, methods are provided for how the UE indicates IDC issues to the network.

In this document, the term “candidate frequency resource” is used to represent a frequency resource for which the UE is to evaluate whether it is affected by IDC issues. It should be noted that a candidate frequency resource may either be a frequency resource that the network may configure for the UE to use, or it can be a frequency resource which the UE is already configured to use.

Note that it may sometimes be described herein that the UE is experiencing IDC issues. But it should be noted that the embodiments described herein can also be applied to a scenario where the UE is not yet experiencing IDC issues, but the UE expects that it will (later) experience IDC issues.

It is herein described how a UE would handle IDC indications using a first FDM granularity and a second FDM granularity. However, only two granularities is just an example. More generally, there may be any number of two or more IDC FDM indication granularities, but it will in some cases be used as example that there are two granularities. The first granularity may be per frequency without specifying a range, e.g. an ARFCN, and the second granularity may be per frequency range, per bandwidth part, per Physical Resource Block (PRB) range, or the like.

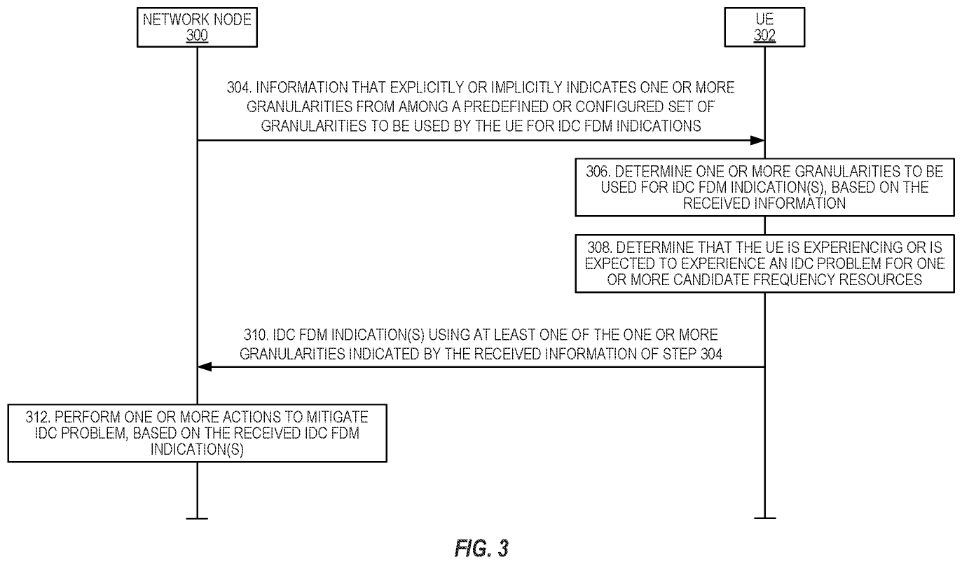

FIG. 3 illustrates the operation of a network node 300 and a UE 302 in accordance with at least some of the embodiments described herein. The network node 300 may be a Radio Access Network (RAN) node such as, e.g., a base station (e.g., an eNB or gNB) or a RAN node that provides some of the functionality of a base station (e.g., an eNB Distributed Unit (DU), gNB-DU, an eNB Central Unit (CU), or a gNB-CU).

As illustrated, the network node 300 sends, to the UE 302, information that explicitly or implicitly indicates one or more granularities from among a predefined or configured set of granularities to be used by the UE 302 for IDC FDM indications (step 304). The predefined or configured set of granularities includes two or more granularities. For example, the set of granularities includes, in one embodiment, a first granularity (e.g., ARFCNs) and a second granularity (e.g., BWPs, frequency ranges, PRB ranges, or the like).

The UE 302 is capable of sending IDC FDM indications using the predefined or configured set of granularities. The UE 302 then operates to provide IDC FDM indications in accordance with the received information. More specifically, in the illustrated embodiment, the UE 302 determines the granularity(ies) to be used for IDC FDM indications based on the information received in step 304 (step 306). The UE 302 determines that it is experiencing or is expected to experience an IDC problem for one or more candidate frequency resources (step 308). Note that step 306 may be performed prior to step 308 or after step 308. The UE 302 then sends, to the network node 300, one or more IDC FDM indications that indicate the one or more candidate frequency resources for which the UE 302 is experiencing or is expected to experience an IDC problem using the determined granularity(ies) (step 310). Note that, if there are two or more IDC FDM indications, these IDC FDM indications may be sent in the same message or, alternatively, in separate messages.

The network node 300 may then use the IDC FDM indication(s) received from the UE 302 to perform one or more actions (e.g., trigger handover of the UE 302, reconfigure the cell, or the like) such that the IDC problems at the UE 302 are mitigated (step 312).

While not being limited to the procedure of FIG. 3, the following description provides further details regarding various aspects of the procedure of FIG. 3.

### UE Capable of Multiple Granularities Uses Only One Granularity

In one embodiment, a UE (e.g., UE 302) is capable of sending IDC indications (e.g., IDC FDM indications) with a first granularity and a second granularity, and the UE decides (e.g., in step 306) to send an IDC indication with the first granularity or the second granularity based on a configuration received from the network, e.g. via higher layer signaling such as, e.g., Radio Resource Control (RRC) signaling (e.g., in step 304).

In one embodiment, the network node (e.g., network node 300) indicates (e.g., in step 304) whether the UE is to indicate IDC issues using the first or second granularity in a configuration which configures the IDC feature. The configuration may be, for example, a flag which, when set to a first value, indicates that the UE is to use a first granularity or, when set to a second value, indicates that the UE is to use a second granularity.

In another embodiment, the network node configures (e.g., in step 304) which granularity the UE is to apply by configuring candidate frequency resources for the UE where each of those candidate frequency resources has a first or a second granularity. In this way, the configuration serves as an implicit indication to the UE that, for each configured candidate frequency resource, the UE is use the corresponding granularity (i.e., the same granularity used to configure the candidate frequency resource is also used for an IDC FDM indication for that candidate frequency resource). In other words, the configuration of the candidate frequency resources implicitly indicates that the UE is to indicate IDC issues with a first or a second granularity, e.g. if the network configures candidate frequency resources with a first granularity (e.g. ARFCNs) the UE will use this first granularity to indicate IDC issues, and if configured with candidate frequency resources of a second granularity (e.g. BWPs, or frequency ranges), the UE will use this second granularity to indicate IDC issues.

The network node (e.g., network node 300) would decide if it wants the UE to send IDC indications using a first or a second granularity and configures the UE with candidate frequency resources having the first or second granularity, respectively.

In another approach, if the UE is configured with a first and a second granularity (e.g., in step 304), the UE determines (e.g., in step 306) that it is to apply only one of these granularities, e.g. only uses the second granularity. This could be useful in case the signaling for the first granularity is mandatory to be included in a message wherein the frequency resources are provided to the UE. It could be seen as the UE would in this case ignore the first granularity that the network configures for the UE. For example, the UE ignores candidate ARFCN, if configured with candidate BWPs or candidate frequency ranges.

In case the UE supports more than two granularities (e.g., three granularities) in its general form, in this embodiment, the network may configure the UE (e.g., in step 304) to use a subset of the three (or more) granularities.

### UE Uses Multiple Granularities

In one embodiment, a network node (e.g., network node 300) configures (e.g., in step 304) the UE (e.g., UE 302) to send IDC issues (e.g., IDC FDM indications) using both a first granularity and a second granularity, and the UE will consider both these granularities when indicating IDC issues, depending on how they are affected by IDC issues, as will be described later on. In other words, the UE may consider both these granularities when determining (e.g., in step 306) which granularity to use when indicating IDC issues (e.g., in step 310).

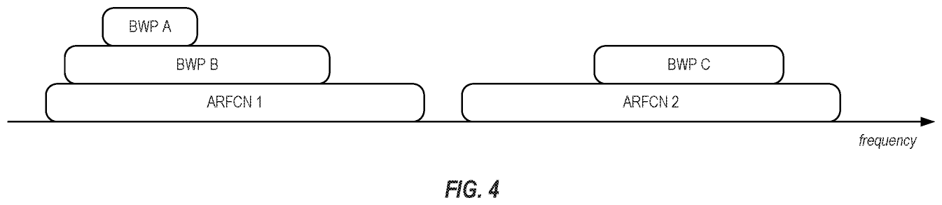

To illustrate this embodiment, FIG. 4 shows a scenario where the UE is configured (e.g., in step 304) with candidate frequency resources with two different granularities: ARFCNs and BWPs. The UE has two candidate ARFCNs (1 and 2) and three candidate BWPs (A, B and C).

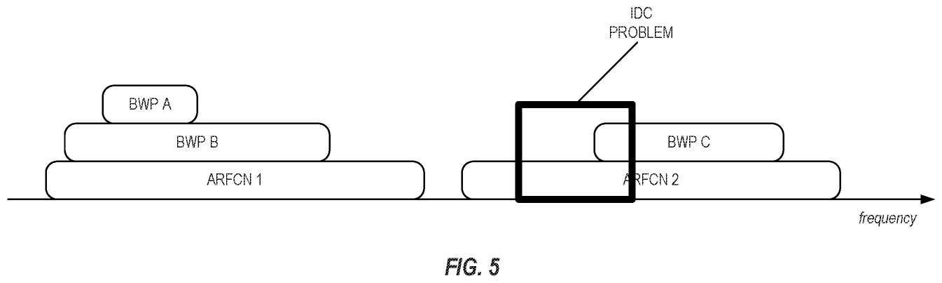

In this example, the UE determines (e.g., in step 308), for each of the candidate frequency resources, whether the UE experiences IDC problems on that candidate frequency resource and indicates, to the network node, those candidate frequency resources which are affected by the IDC problems (e.g., in step 310). In an example shown in FIG. 5, the UE would indicate ARFCN 2 and BWP C as problematic resources, i.e. the UE would include frequency resources of different granularities in the report.

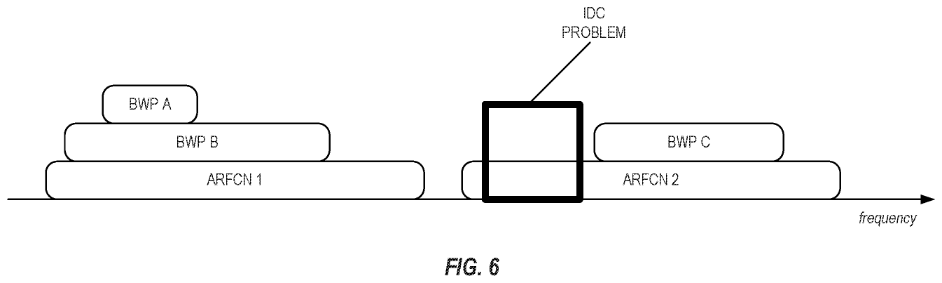

If the IDC problems instead affect the frequency range as shown in the example of FIG. 6, the UE would only indicate ARFCN 2 as problematic since no other frequency resource is affected.

To optimize signaling, if all BWPs of an ARFCN are affected by IDC problems, the UE may omit the ARFCN indications and instead only indicate the BWPs as problematic. This works since a UE is served by BWPs and, if all BWPs of an ARFCN are affected, there is no means to use any resource on the ARFCN and hence there is no need to indicate the ARFCN.

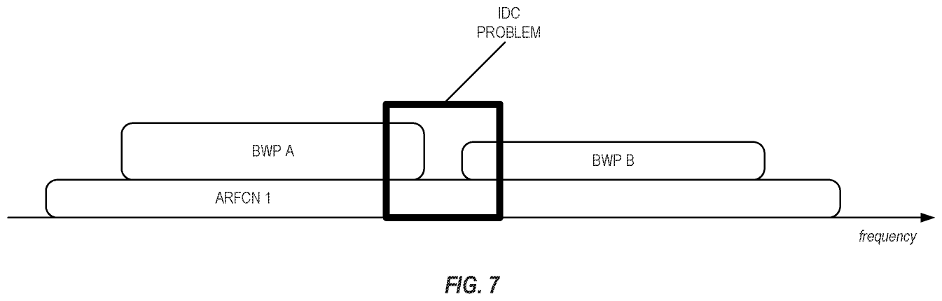

Considering another scenario, another potential signaling optimization when all BWPs associated with an ARFCN are affected by IDC issues, the UE may then indicate only the ARFCN, but omit indications of the BWPs. This will then be interpreted by the network node as all BWPs on the ARFCN are affected, even though the UE did not indicate all those BWPs explicitly. This is illustrated by the example of FIG. 7 where all BWPs (i.e., both BWP A and BWP B in the figure) are affected by IDC problems. The UE would, if it is applying this signaling optimization, only indicate ARFCN 1 which would then mean that all BWPs (A and B) associated with this ARFCN are affected by IDC problems.

### Handling of Frequency Resources of the Same Granularity which are Overlapping

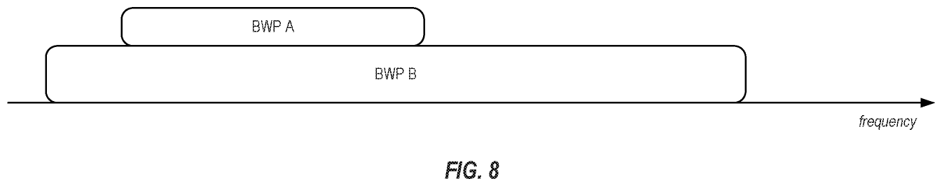

In one embodiment, the UE is configured with candidate frequency resources of the same granularity which are overlapping. This is illustrated by the example of FIG. 8 where the UE is configured with a BWP A and a BWP B as candidate frequency resources, and they are overlapping.

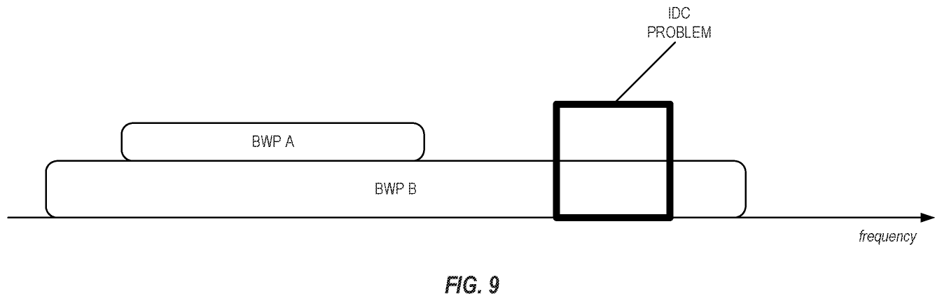

In some scenarios, the UE may experience IDC problems which affect only one of the frequency resources. In the example of FIG. 9, it is shown that the IDC problems affect BWP B but not BWP A. According to one embodiment the UE indicates only the frequency resources which are affected by the IDC problems (BWP B in this example).

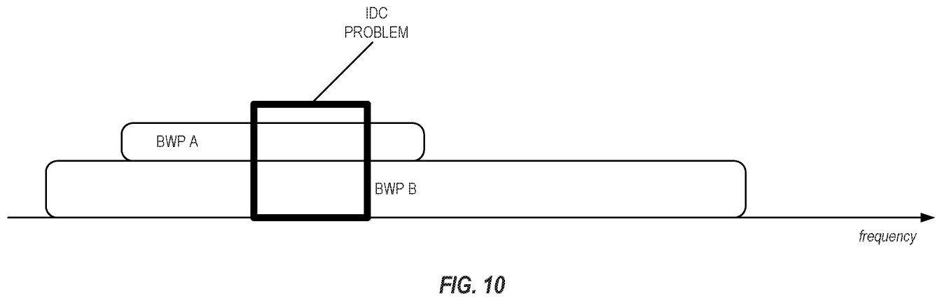

In some scenarios, the UE may experience IDC problems which affect two overlapping candidate frequencies resources (BWP A and BWP B in the example of FIG. 10). In one embodiment, the UE indicates all affected candidate frequency resource, i.e. both BWP A and BWP B. In another embodiment, the UE indicates a subset of the affected frequency resources, e.g. only indicates BWP A since the network would know that if BWP A is affected, BWP B will also be affected. This approach will therefore save some signaling overhead.

### Further Description

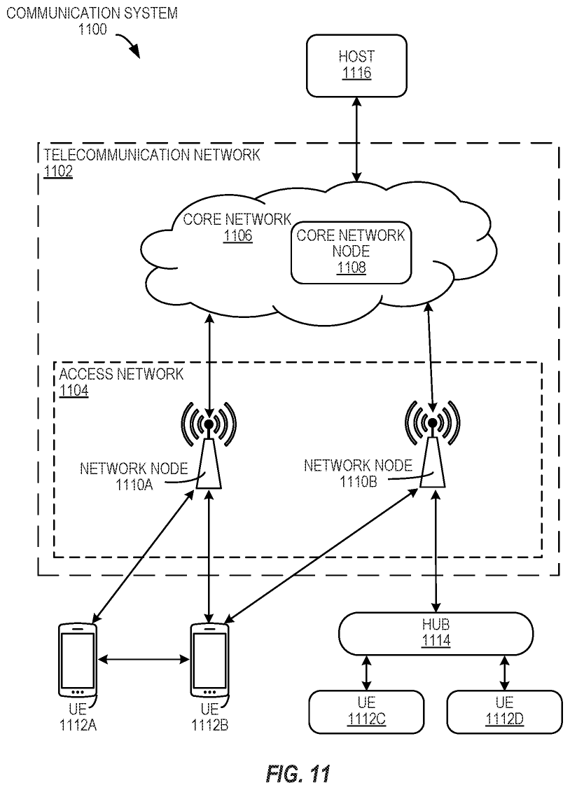

FIG. 11 shows an example of a communication system 1100 in accordance with some embodiments.

In the example, the communication system 1100 includes a telecommunication network 1102 that includes an access network 1104, such as a Radio Access Network (RAN), and a core network 1106, which includes one or more core network nodes 1108. The access network 1104 includes one or more access network nodes, such as network nodes 1110A and 1110B (one or more of which may be generally referred to as network nodes 1110), or any other similar Third Generation Partnership Project (3GPP) access node or non-3GPP Access Point (AP). The network nodes 1110 facilitate direct or indirect connection of User Equipment (UE), such as by connecting UEs 1112A, 1112B, 1112C, and 1112D (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system 1100 may be configured to operate according to predefined rules or procedures, such as specific standards that include, but are not limited to: Global System for Mobile Communications (GSM);

Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1102 is a cellular network that implements 3GPP standardized features. Accordingly, the telecommunication network 1102 may support network slicing to provide different logical networks to different devices that are connected to the telecommunication network 1102. For example, the telecommunication network 1102 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IOT) services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single-or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 1114 communicates with the access network 1104 to facilitate indirect communication between one or more UEs (e.g., UE 1112C and/or 1112D) and network nodes (e.g., network node 1110B). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a Virtual Reality (VR) headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110B. The hub 1114 may also allow for a different communication scheme and/or schedule between the hub 1114 and UEs (e.g., UE 1112C and/or 1112D), and between the hub 1114 and the core network 1106. In other examples, the hub 1114 is connected to the core network 1106 and/or one or more UEs via a wired connection. Moreover, the hub 1114 may be configured to connect to a Machine-to-Machine (M2M) service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub-that is, a hub whose primary function is to route communications to/from the UEs from/to the network node 1110B. In other embodiments, the hub 1114 may be a non-dedicated hub-that is, a device which is capable of operating to route communications between the UEs and the network node 1110B, but which is additionally capable of operating as a communication start and/or end point for certain data channels.

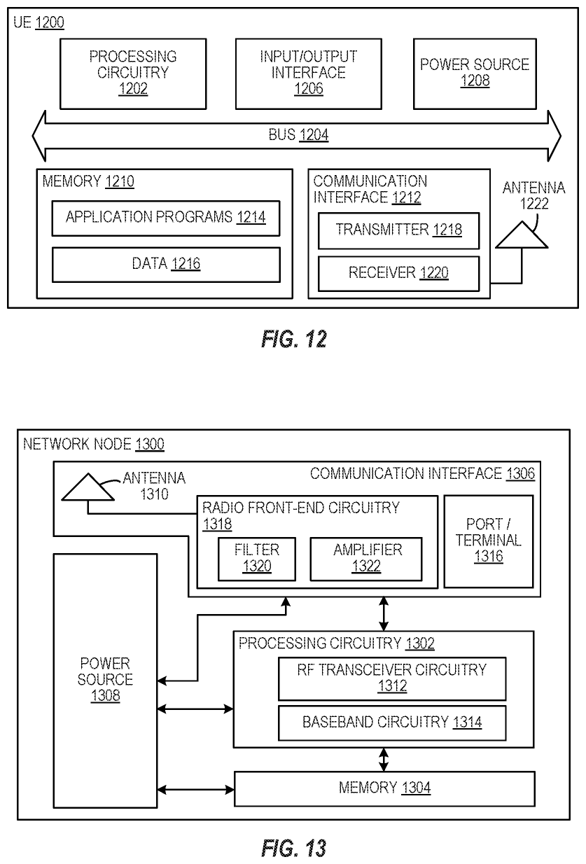

FIG. 12 shows a UE 1200 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1202 may include multiple Central Processing Units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging the power source 1208. Power circuitry may perform any formatting, converting, or other modification to the power from the power source 1208 to make the power suitable for the respective components of the UE 1200 to which power is supplied.

The memory 1210 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1210 may allow the UE 1200 to access instructions, application programs, and the like stored on transitory or non-transitory memory media, to off-load data, or to upload data. An article of manufacture, such as one utilizing a communication system, may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., the antenna 1222) and may share circuit components, software, or firmware, or alternatively be implemented separately.

In the illustrated embodiment, communication functions of the communication interface 1212 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1212, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 13 shows a network node 1300 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes processing circuitry 1302, memory 1304, a communication interface 1306, and a power source 1308. The network node 1300 may be composed of multiple physically separate components (e.g., a Node B component and an RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1300 may be configured to support multiple RATs. In such embodiments, some components may be duplicated (e.g., separate memory 1304 for different RATs) and some components may be reused (e.g., an antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1300.

The processing circuitry 1302 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1300 components, such as the memory 1304, to provide network node 1300 functionality.

In some embodiments, the processing circuitry 1302 includes a System on a Chip (SOC). In some embodiments, the processing circuitry 1302 includes one or more of Radio Frequency (RF) transceiver circuitry 1312 and baseband processing circuitry 1314. In some embodiments, the RF transceiver circuitry 1312 and the baseband processing circuitry 1314 may be on separate chips (or sets of chips), boards, or units, such as radio units and digital units. In alternative embodiments, part or all of the RF transceiver circuitry 1312 and the baseband processing circuitry 1314 may be on the same chip or set of chips, boards, or units.

The memory 1304 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and the memory 1304 are integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. The radio front-end circuitry 1318 comprises filters 1320 and amplifiers 1322. The radio front-end circuitry 1318 may be connected to the antenna 1310 and the processing circuitry 1302. The radio front-end circuitry 1318 may be configured to condition signals communicated between the antenna 1310 and the processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of the filters 1320 and/or the amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface 1306 may comprise different components and/or different combinations of components.

In certain alternative embodiments, the network node 1300 does not include separate radio front-end circuitry 1318; instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes the one or more ports or terminals 1316, the radio front-end circuitry 1318, and the RF transceiver circuitry 1312 as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, the communication interface 1306, and/or the processing circuitry 1302 may be configured to perform any receiving operations and/or certain obtaining operations described herein as being performed by the network node 1300. Any information, data, and/or signals may be received from a UE, another network node, and/or any other network equipment. Similarly, the antenna 1310, the communication interface 1306, and/or the processing circuitry 1302 may be configured to perform any transmitting operations described herein as being performed by the network node 1300. Any information, data, and/or signals may be transmitted to a UE, another network node, and/or any other network equipment.

The power source 1308 provides power to the various components of the network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid or an electricity outlet) via input circuitry or an interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

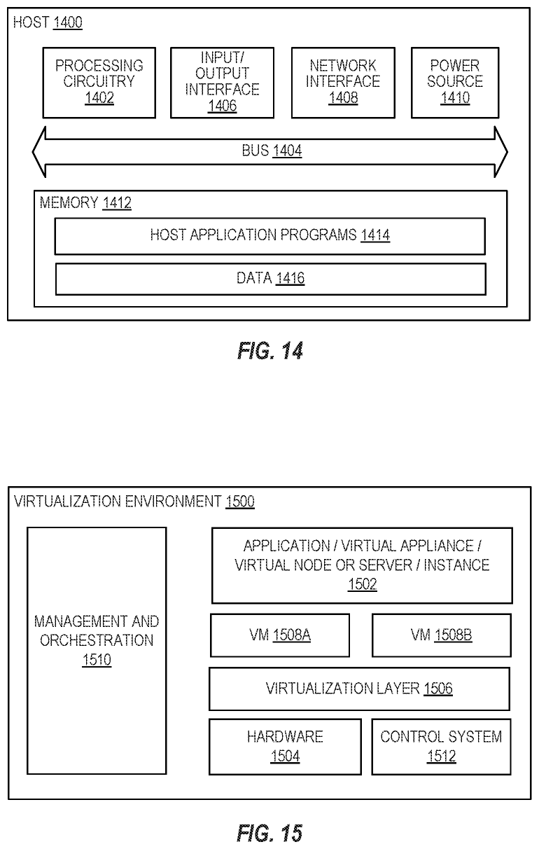

FIG. 14 is a block diagram of a host 1400, which may be an embodiment of the host 1116 of FIG. 11, in accordance with various aspects described herein. As used herein, the host 1400 may be or comprise various combinations of hardware and/or software including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and memory 1412. Other components may be included in other embodiments. Features of these components may be substantially similar to those described with respect to the devices of previous figures, such as FIGS. 12 and 13, such that the descriptions thereof are generally applicable to the corresponding components of the host 1400.

The memory 1412 may include one or more computer programs including one or more host application programs 1414 and data 1416, which may include user data, e.g. data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for Over-The-Top (OTT) services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or VM Monitors (VMMs)), provide VMs 1508A and 1508B (one or more of which may be generally referred to as VMs 1508), and/or perform any of the functions, features, and/or benefits described in relation with some embodiments described herein. The virtualization layer 1506 may present a virtual operating platform that appears like networking hardware to the VMs 1508.

The VMs 1508 comprise virtual processing, virtual memory, virtual networking, or interface and virtual storage, and may be run by a corresponding virtualization layer 1506.

Different embodiments of the instance of a virtual appliance 1502 may be implemented on one or more of the VMs 1508, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1508 may be a software implementation of a physical machine that runs programs as if they were executing on a physical, non-virtualized machine. Each of the VMs 1508, and that part of the hardware 1504 that executes that VM, be it hardware dedicated to that VM and/or hardware shared by that VM with others of the VMs 1508, forms separate virtual network elements. Still in the context of NFV, a virtual network function is responsible for handling specific network functions that run in one or more VMs 1508 on top of the hardware 1504 and corresponds to the application 1502.

The hardware 1504 may be implemented in a standalone network node with generic or specific components. The hardware 1504 may implement some functions via virtualization. Alternatively, the hardware 1504 may be part of a larger cluster of hardware (e.g., such as in a data center or CPE) where many hardware nodes work together and are managed via management and orchestration 1510, which, among others, oversees lifecycle management of the applications 1502. In some embodiments, the hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1512 which may alternatively be used for communication between hardware nodes and radio units.

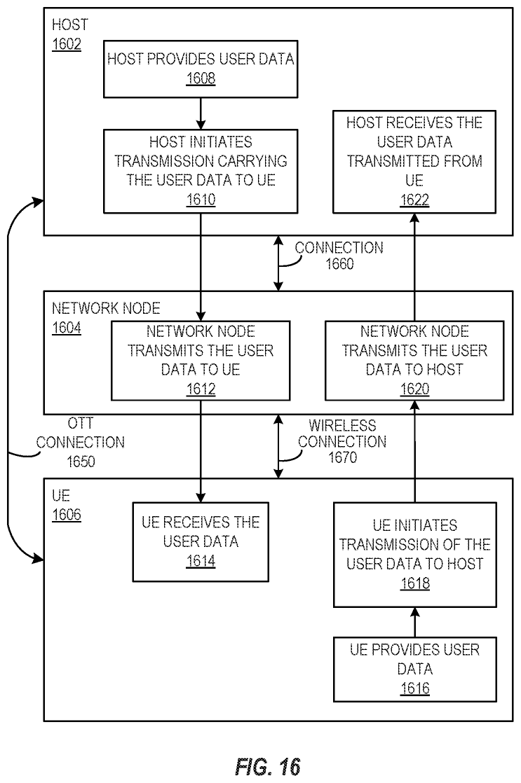

FIG. 16 shows a communication diagram of a host 1602 communicating via a network node 1604 with a UE 1606 over a partially wireless connection in accordance with some embodiments. Example implementations, in accordance with various embodiments, of the UE (such as the UE 1112A of FIG. 11 and/or the UE 1200 of FIG. 12), the network node (such as the network node 1110A of FIG. 11 and/or the network node 1300 of FIG. 13), and the host (such as the host 1116 of FIG. 11 and/or the host 1400 of FIG. 14) discussed in the preceding paragraphs will now be described with reference to FIG. 16.

Like the host 1400, embodiments of the host 1602 include hardware, such as a communication interface, processing circuitry, and memory. The host 1602 also includes software, which is stored in or is accessible by the host 1602 and executable by the processing circuitry. The software includes a host application that may be operable to provide a service to a remote user, such as the UE 1606 connecting via an OTT connection 1650 extending between the UE 1606 and the host 1602. In providing the service to the remote user, a host application may provide user data which is transmitted using the OTT connection 1650.

The network node 1604 includes hardware enabling it to communicate with the host 1602 and the UE 1606 via a connection 1660. The connection 1660 may be direct or pass through a core network (like the core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by the UE 1606 and executable by the UE's processing circuitry. The software includes a client application, such as a web browser or operator-specific “app” that may be operable to provide a service to a human or non-human user via the UE 1606 with the support of the host 1602. In the host 1602, an executing host application may communicate with the executing client application via the OTT connection 1650 terminating at the UE 1606 and the host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via the connection 1660 between the host 1602 and the network node 1604 and via a wireless connection 1670 between the network node 1604 and the UE 1606 to provide the connection between the host 1602 and the UE 1606. The connection 1660 and the wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604 in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR, or AR which it can broadcast, multicast, or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1650 between the host 1602 and the UE 1606 in response to variations in the measurement results. The measurement procedure and/or the network functionality for reconfiguring the OTT connection 1650 may be implemented in software and hardware of the host 1602 and/or the UE 1606. In some embodiments, sensors (not shown) may be deployed in or in association with other devices through which the OTT connection 1650 passes; the sensors may participate in the measurement procedure by supplying values of the monitored quantities exemplified above, or by supplying values of other physical quantities from which software may compute or estimate the monitored quantities. The reconfiguring of the OTT connection 1650 may include message format, retransmission settings, preferred routing, etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency, and the like by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### Group A Embodiments

Embodiment 1: A method performed by a User Equipment (302), the method comprising: receiving (304), from a network node (300), information that explicitly or implicitly indicates one or more granularities to be used by the UE (302) for In-Device Co-existence, IDC, Frequency Domain Multiplexing, FDM, indications, the one or more granularities being one or more of a predefined or configured set of two or more granularities that can be used for IDC FDM indications; and providing (306-310), to the network node (300), one or more IDC FDM indications in accordance with the information.

Embodiment 2: The method of embodiment 1 wherein providing (306-310) the one or more IDC FDM indications in accordance with the information comprises providing (306-310) the one or more IDC FDM indications using a single granularity indicated by the received information.

Embodiment 3: The method of embodiment 1 wherein providing (306-310) the one or more IDC FDM indications in accordance with the information comprises providing (306-310) the one or more IDC FDM indications using a single granularity selected from two or more granularities indicated by the received information.

Embodiment 4: The method of embodiment 1 wherein the one or more granularities to be used by the UE (302) for IDC FDM indications consist of a single granularity to be used by the UE (302) for IDC FDM indications.

Embodiment 5: The method of embodiment 1 wherein: the information that explicitly or implicitly indicates the one or more granularities to be used by the UE (302) for IDC FDM indications comprises information that configures one or more candidate frequency resources; and, for each candidate frequency resource of the one or more candidate frequency resources configured for the UE (302), a granularity used to configure the candidate frequency resource serves as an implicit indication of a granularity to be used by the UE (302) when sending an IDC FDM indication for that candidate frequency resource.

Embodiment 6: The method of embodiment 1 wherein: the one or more granularities to be used by the UE (302) for IDC FDM indications consists of two or more granularities; and providing (306-310) the one or more IDC FDM indications in accordance with the information comprises determining (306) one of the two or more granularities to use when providing the one or more IDC FDM indications.

Embodiment 7: The method of embodiment 1 wherein the one or more granularities indicated by the received information comprise two or more granularities, and providing (306-310) the one or more IDC FDM indications in accordance with the information comprises providing (306-310) two or more IDC FDM indications using at least two of the two or more granularities indicated by the received information.

Embodiment 8: The method of embodiment 1 wherein: the one or more granularities indicated by the received information comprise two or more granularities; and providing (306-310) the one or more IDC FDM indications in accordance with the information comprises providing (306-310) two or more IDC FDM indications in accordance with the information, wherein providing (306-310 the two or more IDC FDM indications comprises determining (306) at least two of the two or more granularities to be used when providing the two or more IDC FDM indications.

Embodiment 9: The method of embodiment 1 wherein:
the one or more granularities indicated by the received information comprise two or more granularities;
providing (306-310) the one or more IDC FDM indications in accordance with the information comprises:
   determining (308) two or more candidate frequency resources for which the UE (302) is experiencing or is expected to experience an IDC problem, wherein at least one of the two or more candidate frequency resources is configured using a first granularity from among the two or more granularities and at least one other of the two or more candidate frequency resources is configured using a second granularity from among the two or more granularities;
   determining (306) at least one of the first and second granularities to be used when sending at least one IDC FDM indication that explicitly or implicitly indicates the two or more candidate frequency resources for which the UE (302) is experiencing or is expected to experience an IDC problem; and
   sending (310), to the network node (300), the at least one IDC FDM indication that explicitly or implicitly indicates the two or more candidate frequency resources for which the UE (302) is experiencing or is expected to experience an IDC problem, the at least one IDC FDM indication sent using the determined at least one of the first and second granularities.

Embodiment 10: The method of embodiment 1 wherein:
the one or more granularities indicated by the received information comprise two or more granularities;
providing (306-310) the one or more IDC FDM indications in accordance with the information comprises:
   determining (308) two or more candidate frequency resources for which the UE (302) is experiencing or is expected to experience an IDC problem, wherein the two or more candidate frequency resources for which the UE (302) is experiencing or is expected to experience an IDC problem comprises a first candidate frequency resource configured using a first granularity from among the two or more granularities and a second candidate frequency resource configured using a second granularity from among the two or more granularities;
   sending (310), to the network node (300), a first IDC FDM indication for the first candidate frequency resource and a second IDC FDM indication for the second candidate frequency resource, wherein the first IDC FDM indication uses the first granularity and the second IDC FDM indication uses the second granularity.

Embodiment 11: The method of embodiment 1 wherein:
the one or more granularities indicated by the received information comprise two or more granularities;
providing (306-310) the one or more IDC FDM indications in accordance with the information comprises:
   determining (308) two or more candidate frequency resources for which the UE (302) is experiencing or is expected to experience an IDC problem, wherein the two or more candidate frequency resources for which the UE (302) is experiencing or is expected to experience an IDC problem comprises:
   a first candidate frequency resource configured using a first granularity from among the two or more granularities; and
   a second candidate frequency resource configured using a second granularity from among the two or more granularities, wherein the first granularity is coarser than the second granularity and the first and second candidate frequency resources overlap;
   sending (310), to the network node (300), an IDC FDM indication for the second candidate frequency resource, wherein the IDC FDM indication also implicitly indicates an IDC problem for the first candidate frequency resource that overlaps the second candidate frequency resource.

Embodiment 12: The method of embodiment 1 wherein:
the one or more granularities indicated by the received information comprise two or more granularities;
providing (306-310) the one or more IDC FDM indications in accordance with the information comprises:
   determining (308) two or more candidate frequency resources for which the UE (302) is experiencing or is expected to experience an IDC problem, wherein the two or more candidate frequency resources for which the UE (302) is experiencing or is expected to experience an IDC problem comprises:
   a first candidate frequency resource configured using a first granularity from among the two or more granularities; and
   a second candidate frequency resource configured using a second granularity from among the two or more granularities, wherein the first granularity is coarser than the second granularity and the first and second candidate frequency resources overlap;
   sending (310), to the network node (300), an IDC FDM indication for the first candidate frequency resource, wherein the IDC FDM indication also implicitly indicates an IDC problem for the second candidate frequency resource that overlaps the second candidate frequency resource.

Embodiment 13: The method of embodiment 1 wherein:
the one or more granularities indicated by the received information comprise two or more granularities;
providing (306-310) the one or more IDC FDM indications in accordance with the information comprises:
   determining (308) two or more candidate frequency resources for which the UE (302) is experiencing or is expected to experience an IDC problem, wherein the two or more candidate frequency resources for which the UE (302) is experiencing or is expected to experience an IDC problem comprises:
   a first candidate frequency resource configured using a first granularity from among the two or more granularities; and
   a second candidate frequency resource configured using the first granularity, wherein the first candidate frequency resource overlaps (e.g., is entirely within) the second candidate frequency resource;
   sending (310), to the network node (300), an IDC FDM indication for the first candidate frequency resource, wherein the IDC FDM indication also implicitly indicates an IDC problem for the second candidate frequency resource.

Embodiment 14: The method of any of the previous embodiments, further comprising: providing user data; and forwarding the user data to a host via the transmission to the network node.

### Group B Embodiments

Embodiment 15: A method performed by a network node (300), the method comprising: sending (304), to a User Equipment (302), information that explicitly or implicitly indicates one or more granularities to be used by the UE (302) for In-Device Co-existence, IDC, Frequency Domain Multiplexing, FDM, indications, the one or more granularities being one or more of a predefined or configured set of two or more granularities that can be used for IDC FDM indications; and receiving (310), from the UE (302), one or more IDC FDM indications in accordance with the information.

Embodiment 16: The method of embodiment 15 further comprising performing (312) one or more actions based on the one or more IDC FDM indications received from the UE (302).

Embodiment 17: The method of embodiment 15 or 16 wherein the one or more IDC FDM indications use a single granularity indicated by the information sent to the UE (302).

Embodiment 18: The method of embodiment 15 or 16 wherein the one or more IDC FDM indications use a single granularity selected from two or more granularities indicated by the information sent to the UE (302).

Embodiment 19: The method of embodiment 15 or 16 wherein the one or more granularities to be used by the UE (302) for IDC FDM indications consist of a single granularity to be used by the UE (302) for IDC FDM indications.

Embodiment 20: The method of embodiment 15 or 16 wherein: the information that explicitly or implicitly indicates the one or more granularities to be used by the UE (302) for IDC FDM indications comprises information that configures one or more candidate frequency resources; and, for each candidate frequency resource of the one or more candidate frequency resources configured for the UE (302), a granularity used to configure the candidate frequency resource serves as an implicit indication of a granularity to be used by the UE (302) when sending an IDC FDM indication for that candidate frequency resource.

Embodiment 21: The method of embodiment 15 or 16 wherein: the one or more granularities to be used by the UE (302) for IDC FDM indications consists of two or more granularities; and the one or more IDC FDM indications use at least two of the two or more granularities.

Embodiment 22: The method of embodiment 15 or 16 wherein: the one or more granularities indicated by the received information comprise two or more granularities; and the one or more IDC FDM indications comprises a first IDC FDM indication using a first granularity from among the two or more granularities and a second IDC FDM indication using a second granularity from among the two or more granularities.

Embodiment 23: The method of embodiment 15 or 16 wherein:
the one or more granularities indicated by the information comprise two or more granularities;
the one or more IDC FDM indications comprise at least one IDC FDM indication that explicitly or implicitly indicates two or more candidate frequency resources for which the UE (302) is experiencing or is expected to experience an IDC problem, wherein:
   at least one of the two or more candidate frequency resources is configured to the UE (302) using a first granularity from among the two or more granularities and at least one other of the two or more candidate frequency resources is configured to the UE (302) using a second granularity from among the two or more granularities; and
   the at least one IDC FDM indication is sent using at least one of the first and second granularities.

Embodiment 24: The method of embodiment 15 or 16 wherein: the one or more granularities indicated by the received information comprise two or more granularities; the UE (302) is configured with a plurality of candidate frequency resources comprising a first candidate frequency resource configured using a first granularity from among the two or more granularities and a second candidate frequency resource configured using a second granularity from among the two or more granularities; and the one or more IDC FDM indications comprise a first IDC FDM indication for the first candidate frequency resource and a second IDC FDM indication for the second candidate frequency resource, wherein the first IDC FDM indication uses the first granularity and the second IDC FDM indication uses the second granularity.

Embodiment 25: The method of embodiment 15 or 16 wherein:
the one or more granularities indicated by the received information comprise two or more granularities;
the UE (302) is configured with a plurality of candidate frequency resources comprising:
   a first candidate frequency resource configured using a first granularity from among the two or more granularities; and
   a second candidate frequency resource configured using a second granularity from among the two or more granularities, wherein the first granularity is coarser than the second granularity and the first and second candidate frequency resources overlap; and
the one or more IDC FDM indications comprise an IDC FDM indication for the second candidate frequency resource, wherein the IDC FDM indication also implicitly indicates an IDC problem for the first candidate frequency resource that overlaps the second candidate frequency resource.

Embodiment 26: The method of embodiment 15 or 16 wherein:
the one or more granularities indicated by the received information comprise two or more granularities;
the UE (302) is configured with a plurality of candidate frequency resources comprising:
   a first candidate frequency resource configured using a first granularity from among the two or more granularities; and
   a second candidate frequency resource configured using a second granularity from among the two or more granularities, wherein the first granularity is coarser than the second granularity and the first and second candidate frequency resources overlap; and
the one or more IDC FDM indications comprise an IDC FDM indication for the first candidate frequency resource, wherein the IDC FDM indication also implicitly indicates an IDC problem for the second candidate frequency resource that overlaps the second candidate frequency resource.

Embodiment 27: The method of embodiment 15 or 16 wherein:
the one or more granularities indicated by the received information comprise two or more granularities;
the UE (302) is configured with a plurality of candidate frequency resources comprising:
   a first candidate frequency resource configured using a first granularity from among the two or more granularities; and
   a second candidate frequency resource configured using the first granularity, wherein the first candidate frequency resource overlaps (e.g., is entirely within) the second candidate frequency resource; and
the one or more IDC FDM indications comprise an IDC FDM indication for the first candidate frequency resource, wherein the IDC FDM indication also implicitly indicates an IDC problem for the second candidate frequency resource.

Embodiment 28: The method of any of the previous embodiments, further comprising: obtaining user data; and forwarding the user data to a host or a user equipment.

### Group C Embodiments

Embodiment 29: A user equipment comprising: processing circuitry configured to perform any of the steps of any of the Group A embodiments; and power supply circuitry configured to supply power to the processing circuitry.

Embodiment 30: A network node comprising: processing circuitry configured to perform any of the steps of any of the Group B embodiments; and power supply circuitry configured to supply power to the processing circuitry.

Embodiment 31: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 32: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 33: The host of the previous embodiment, wherein the cellular network further includes a network node configured to communicate with the UE to transmit the user data to the UE from the host.

Embodiment 34: The host of the previous 2 embodiments, wherein: the processing circuitry of the host is configured to execute a host application, thereby providing the user data; and the host application is configured to interact with a client application executing on the UE, the client application being associated with the host application.

Embodiment 35: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 36: The method of the previous embodiment, further comprising: at the host, executing a host application associated with a client application executing on the UE to receive the user data from the UE.

Embodiment 37: The method of the previous embodiment, further comprising: at the host, transmitting input data to the client application executing on the UE, the input data being provided by executing the host application, wherein the user data is provided by the client application in response to the input data from the host application.

Embodiment 38: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 39: The host of the previous embodiment, wherein the cellular network further includes a network node configured to communicate with the UE to transmit the user data from the UE to the host.

Embodiment 40: The host of the previous 2 embodiments, wherein: the processing circuitry of the host is configured to execute a host application, thereby providing the user data; and the host application is configured to interact with a client application executing on the UE, the client application being associated with the host application.

Embodiment 41: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 42: the method of the previous embodiment, further comprising: at the host, executing a host application associated with a client application executing on the UE to receive the user data from the UE.

Embodiment 43: The method of the previous embodiment, further comprising: at the host, transmitting input data to the client application executing on the UE, the input data being provided by executing the host application, wherein the user data is provided by the client application in response to the input data from the host application.

Embodiment 44: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 45: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 46: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 47: The method of the previous embodiment, further comprising, at the network node, transmitting the user data provided by the host for the UE.

Embodiment 48: The method of any of the previous 2 embodiments, wherein the user data is provided at the host by executing a host application that interacts with a client application executing on the UE, the client application being associated with the host application.

Embodiment 49: A communication system configured to provide an over-the-top service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 50: The communication system of the previous embodiment, further comprising: the network node; and/or the user equipment.

Embodiment 51: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 52: The host of the previous 2 embodiments, wherein: the processing circuitry of the host is configured to execute a host application, thereby providing the user data; and the host application is configured to interact with a client application executing on the UE, the client application being associated with the host application.

Embodiment 53: The host of the any of the previous 2 embodiments, wherein the initiating receipt of the user data comprises requesting the user data.

Embodiment 54: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 55: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment (UE), the method comprising:
receiving, from a network node, information that explicitly or implicitly indicates one or more granularities to be used by the UE for In-Device Co-existence (IDC) Frequency Domain Multiplexing (FDM) indications, the one or more granularities being one or more of a predefined or configured set of two or more granularities that can be used for IDC FDM indications; and
providing, to the network node, one or more IDC FDM indications in accordance with the information.

2. The method of claim 1 wherein providing the one or more IDC FDM indications in accordance with the information comprises providing the one or more IDC FDM indications using a single granularity indicated by the received information.

3. The method of claim 1 wherein providing the one or more IDC FDM indications in accordance with the information comprises providing the one or more IDC FDM indications using a single granularity selected from two or more granularities indicated by the received information.

4. The method of claim 1 wherein the one or more granularities to be used by the UE for IDC FDM indications consist of a single granularity to be used by the UE for IDC FDM indications.

5. The method of claim 1 wherein:
the information that explicitly or implicitly indicates the one or more granularities to be used by the UE for IDC FDM indications comprises information that configures one or more candidate frequency resources; and
for each candidate frequency resource of the one or more candidate frequency resources configured for the UE, a granularity used to configure the candidate frequency resource serves as an implicit indication of a granularity to be used by the UE when sending an IDC FDM indication for that candidate frequency resource.

6. The method of claim 1 wherein:
the one or more granularities to be used by the UE for IDC FDM indications consists of two or more granularities; and
providing the one or more IDC FDM indications in accordance with the information comprises determining one of the two or more granularities to use when providing the one or more IDC FDM indications.

7. The method of claim 1 wherein the one or more granularities indicated by the received information comprise two or more granularities, and providing the one or more IDC FDM indications in accordance with the information comprises providing two or more IDC FDM indications using at least two of the two or more granularities indicated by the received information.

8. The method of claim 1 wherein:
the one or more granularities indicated by the received information comprise two or more granularities; and
providing the one or more IDC FDM indications in accordance with the information comprises providing two or more IDC FDM indications in accordance with the information, wherein providing the two or more IDC FDM indications comprises:
determining at least two of the two or more granularities to be used when providing the two or more IDC FDM indications.

9. The method of claim 1 wherein:
the one or more granularities indicated by the received information comprise two or more granularities; and
providing the one or more IDC FDM indications in accordance with the information comprises:
determining two or more candidate frequency resources for which the UE is experiencing or is expected to experience an IDC problem, wherein at least one of the two or more candidate frequency resources is configured using a first granularity from among the two or more granularities and at least one other of the two or more candidate frequency resources is configured using a second granularity from among the two or more granularities;
determining at least one of the first and second granularities to be used when sending at least one IDC FDM indication that explicitly or implicitly indicates the two or more candidate frequency resources for which the UE is experiencing or is expected to experience an IDC problem; and
sending, to the network node, the at least one IDC FDM indication that explicitly or implicitly indicates the two or more candidate frequency resources for which the UE is experiencing or is expected to experience an IDC problem, the at least one IDC FDM indication sent using the determined at least one of the first and second granularities.

10. The method of claim 1 wherein:
the one or more granularities indicated by the received information comprise two or more granularities; and
providing the one or more IDC FDM indications in accordance with the information comprises:
determining two or more candidate frequency resources for which the UE is experiencing or is expected to experience an IDC problem, wherein the two or more candidate frequency resources for which the UE is experiencing or is expected to experience an IDC problem comprises a first candidate frequency resource configured using a first granularity from among the two or more granularities and a second candidate frequency resource configured using a second granularity from among the two or more granularities; and
sending, to the network node, a first IDC FDM indication for the first candidate frequency resource and a second IDC FDM indication for the second candidate frequency resource, wherein the first IDC FDM indication uses the first granularity and the second IDC FDM indication uses the second granularity.

11. The method of claim 1 wherein:
the one or more granularities indicated by the received information comprise two or more granularities; and
providing the one or more IDC FDM indications in accordance with the information comprises:
determining two or more candidate frequency resources for which the UE is experiencing or is expected to experience an IDC problem, wherein the two or more candidate frequency resources for which the UE is experiencing or is expected to experience an IDC problem comprises:
a first candidate frequency resource configured using a first granularity from among the two or more granularities; and
a second candidate frequency resource configured using a second granularity from among the two or more granularities, wherein the first granularity is coarser than the second granularity and the first and second candidate frequency resources overlap; and
sending, to the network node, an IDC FDM indication for the second candidate frequency resource, wherein the IDC FDM indication also implicitly indicates an IDC problem for the first candidate frequency resource that overlaps the second candidate frequency resource.

12. The method of claim 1 wherein:
the one or more granularities indicated by the received information comprise two or more granularities; and
providing the one or more IDC FDM indications in accordance with the information comprises:
determining two or more candidate frequency resources for which the UE is experiencing or is expected to experience an IDC problem, wherein the two or more candidate frequency resources for which the UE is experiencing or is expected to experience an IDC problem comprises:
a first candidate frequency resource configured using a first granularity from among the two or more granularities; and
a second candidate frequency resource configured using a second granularity from among the two or more granularities, wherein the first granularity is coarser than the second granularity and the first and second candidate frequency resources overlap; and
sending, to the network node, an IDC FDM indication for the first candidate frequency resource, wherein the IDC FDM indication also implicitly indicates an IDC problem for the second candidate frequency resource that overlaps the second candidate frequency resource.

13. The method of claim 1 wherein:
the one or more granularities indicated by the received information comprise two or more granularities;
providing the one or more IDC FDM indications in accordance with the information comprises:
determining two or more candidate frequency resources for which the UE is experiencing or is expected to experience an IDC problem, wherein the two or more candidate frequency resources for which the UE is experiencing or is expected to experience an IDC problem comprises:
a first candidate frequency resource configured using a first granularity from among the two or more granularities; and
a second candidate frequency resource configured using the first granularity, wherein the first candidate frequency resource is entirely within the second candidate frequency resource; and
sending, to the network node, an IDC FDM indication for the first candidate frequency resource, wherein the IDC FDM indication also implicitly indicates an IDC problem for the second candidate frequency resource.

14-15. (canceled)

16. A User Equipment (UE) comprising:
a communication interface; and
processing circuitry associated with the communication interface, the processing circuitry configured to cause the UE to:
receive, from a network node, information that explicitly or implicitly indicates one or more granularities to be used by the UE for In-Device Co-existence (IDC) Frequency Domain Multiplexing (FDM) indications, the one or more granularities being one or more of a predefined or configured set of two or more granularities that can be used for IDC FDM indications; and
provide, to the network node, one or more IDC FDM indications in accordance with the information.

17. (canceled)

18. A method performed by a network node, the method comprising:
sending, to a User Equipment (UE), information that explicitly or implicitly indicates one or more granularities to be used by the UE for In-Device Co-existence (IDC) Frequency Domain Multiplexing (FDM) indications, the one or more granularities being one or more of a predefined or configured set of two or more granularities that can be used for IDC FDM indications; and
receiving, from the UE, one or more IDC FDM indications in accordance with the information.

19. The method of claim 18 further comprising performing one or more actions based on the one or more IDC FDM indications received from the UE.

20. The method of claim 18 wherein the one or more IDC FDM indications use a single granularity indicated by the information sent to the UE.

21. The method of claim 18 wherein the one or more IDC FDM indications use a single granularity selected from two or more granularities indicated by the information sent to the UE.

22. The method of claim 18 wherein the one or more granularities to be used by the UE for IDC FDM indications consist of a single granularity to be used by the UE for IDC FDM indications.

23. The method of claim 18 wherein:
the information that explicitly or implicitly indicates the one or more granularities to be used by the UE for IDC FDM indications comprises information that configures one or more candidate frequency resources; and
for each candidate frequency resource of the one or more candidate frequency resources configured for the UE, a granularity used to configure the candidate frequency resource serves as an implicit indication of a granularity to be used by the UE when sending an IDC FDM indication for that candidate frequency resource.

24. The method of claim 18 wherein:
the one or more granularities to be used by the UE for IDC FDM indications consists of two or more granularities; and
the one or more IDC FDM indications use at least two of the two or more granularities.

25. The method of claim 18 wherein:
the one or more granularities indicated by the received information comprise two or more granularities; and
the one or more IDC FDM indications comprises a first IDC FDM indication using a first granularity from among the two or more granularities and a second IDC FDM indication using a second granularity from among the two or more granularities.

26. The method of claim 18 wherein:
the one or more granularities indicated by the information comprise two or more granularities; and
the one or more IDC FDM indications comprise at least one IDC FDM indication that explicitly or implicitly indicates two or more candidate frequency resources for which the UE is experiencing or is expected to experience an IDC problem, wherein:
at least one of the two or more candidate frequency resources is configured to the UE using a first granularity from among the two or more granularities and at least one other of the two or more candidate frequency resources is configured to the UE using a second granularity from among the two or more granularities; and
the at least one IDC FDM indication is sent using at least one of the first and second granularities.

27. The method of claim 18 wherein:
the one or more granularities indicated by the received information comprise two or more granularities;
the UE is configured with a plurality of candidate frequency resources comprising a first candidate frequency resource configured using a first granularity from among the two or more granularities and a second candidate frequency resource configured using a second granularity from among the two or more granularities; and
the one or more IDC FDM indications comprise a first IDC FDM indication for the first candidate frequency resource and a second IDC FDM indication for the second candidate frequency resource, wherein the first IDC FDM indication uses the first granularity and the second IDC FDM indication uses the second granularity.

28. The method of claim 18 wherein:
the one or more granularities indicated by the received information comprise two or more granularities;
the UE is configured with a plurality of candidate frequency resources comprising:
a first candidate frequency resource configured using a first granularity from among the two or more granularities; and
a second candidate frequency resource configured using a second granularity from among the two or more granularities, wherein the first granularity is coarser than the second granularity and the first and second candidate frequency resources overlap; and
the one or more IDC FDM indications comprise an IDC FDM indication for the second candidate frequency resource, wherein the IDC FDM indication also implicitly indicates an IDC problem for the first candidate frequency resource that overlaps the second candidate frequency resource.

29-32. (canceled)

33. A network node comprising processing circuitry configured to cause the network node to:
send, to a User Equipment (UE), information that explicitly or implicitly indicates one or more granularities to be used by the UE for In-Device Co-existence (IDC) Frequency Domain Multiplexing (FDM) indications, the one or more granularities being one or more of a predefined or configured set of two or more granularities that can be used for IDC FDM indications; and
receive, from the UE, one or more IDC FDM indications in accordance with the information.

34. (canceled)
